(19) United States
(12) Patent Application Publication
(10) Pub. No.: US 2010/0260963 A1
(43) Pub. Date: Oct. 14, 2010

(54) ANTI-SKID EXERCISE MAT

(76) Inventor: Pao-Lan FENG SHEN, Taichung County (TW)

Correspondence Address: BACON & THOMAS, PLLC, 625 SLATERS LANE, FOURTH FLOOR, ALEXANDRIA, VA, 22314-1176, US

(21) Appl. No.: 12/822,649

(22) Filed: Jun. 24, 2010

Related U.S. Application Data
(63) Continuation-in-part of application No. 12/076,296, filed on Mar. 17, 2008.

(30) Foreign Application Priority Data
Oct. 26, 2007 (TW) 96140166

(51) Int. Cl. B32B 3/16; B32B 3/26; B32B 3/02

(52) U.S. Cl. 428/71; 428/196; 428/114; 428/159; 428/85; 428/96; 428/152

(57) ABSTRACT

An anti-skid exercise mat includes a foam member having a predetermined thickness, a fabric layer located on at least one side of the foam member, and at least one soft plastic material disposed on a predetermined area of a surface of the fabric layer and at least penetrating into the fabric layer for a predetermined depth for scarf joint and adhesive connection with fibers of the fabric layer. Accordingly, the anti-skid exercise mat has preferable anti-skid and perspiration-absorptive functions during the whole course of exercising.

### CROSS REFERENCE TO RELATED APPLICATIONS

The present application is a continuation-in-part of U.S. patent application Ser. No. 12/076,296 entitled ANTI-SKID EXERCISE MAT filed on Mar. 12, 2008, the disclosure of which is incorporated herein by reference.

### BACKGROUND OF THE INVENTION

1. Field of the Invention

The present invention relates generally to an exercise mat, and more particularly, to an anti-skid exercise mat.

2. Description of the Related Art

Generally speaking in the prior art, there are two kinds of conventional exercise mats as mentioned below.

One of them includes a plastic or rubber foam member and a fabric layer adhered onto the foam member. A user can place this exercise mat on the floor and do exercise on the exercise mat. When the user sweats, the fabric layer provides absorption of perspiration and proper anti-skid function for the user's palms and body. The foam member also provides protection and buffer for the user. For example, Taiwan Patent Publication No. M251622 filed on Jan. 6, 2004 and published on Dec. 1, 2004 disclosed a typical exercise mat, which is an elongated mat having an air-permeable foam layer and a fabric mesh layer adhered onto the foam layer.

The other includes only one plastic or rubber foam member without the fabric layer adhered to the foam member, having a pure plastic or rubber surface. When the user does not sweat or sweats a little, it provides good anti-skid function for the user. For example, Taiwan Patent Publication No. M274136 published on Sep. 1, 2005 disclosed a typical exercise mat made of plastic foam.

The aforesaid exercise mats have some limited functions. For examples, a plastic or rubber foam member 10a shown in FIG. 1 or an exercise mat, whose surface is adhered with a plastic or rubber leather layer 12a, as shown in FIG. 2, provides good anti-skid function for the user's hands only when they do not sweat. When the user sweats, the surface of the plastic or rubber foam member 10a or the plastic or rubber leather layer 12a not only fails to provide good absorption of perspiration and good anti-skid function, but also even incurs sliding of the user's palms on the exercise mat. Another fabric layer 11a adhered to the surface of the foam member 10a, as shown in FIG. 3, is contrary to the aforesaid exercise mat in function. When the user's hands do not sweat or the user's palms are dry, there is no preferable resistance between the palms and the fabric layer, so that the palms tend to slide on the surface of the exercise mat. However, when the user's palms sweats or are wet, the exercise mat having the fabric layer 11a located on the surface thereof provides excellent absorption of perspiration and proper anti-skid function.

The user usually does not sweat on the palms while exercising in the beginning, such that the conventional exercise mat made of either plastic or rubber foam 10a or plastic or rubber leather layer 12a can provide good anti-skid function. However, when the user begins to sweat after exercising for a while, not only does the surface of such the conventional exercise mat fail to provide good absorption of perspiration and good anti-skid function, but also the perspiration lets the user feel uncomfortable. At this moment, the user needs the exercise mat having the fabric layer 11a located on the surface thereof to facilitate absorption of perspiration and to stop slipperiness. In other words, when the user's palms do not sweat, the user needs the exercise mat having the plastic or rubber foam member 10a or the plastic or rubber leather layer 12a to help stop slipperiness; when the palms begins to sweat, the user needs the exercise mat having the fabric layer 11a instead of the plastic or rubber foam member 10a or the plastic or rubber leather layer 12a to help absorption of perspiration and stop slipperiness. For this reason, it is very inconvenient for the user to switch one of the exercise mats to the other while exercising. Particularly, while doing yoga, the user often needs to put the palms on the exercise mat during the whole course of yoga. Therefore, the user looks forward to an improved exercise mat, which can stop slipperiness during the whole course no matter whether the palms sweat or not.

In addition, U.S. Patent Publication No. 2005/0125901 disclosed a pillow having a plurality of soft plastic grains disposed on the surface of its fabric layer. US Patent Publication No. 200510192158 disclosed a yoga mat also having a plurality of soft plastic materials disposed on the surface of its fabric layer. Similarly, US Patent Publication No. 2004/0250346 disclosed a yoga mat having viscoid polymers either disposed on the bottom side of its fabric layer and running through the fabric layer or disposed on the top side of the fabric layer.

All of the aforesaid prior art did not disclose that the soft plastic materials penetrate through the surface of the fabric layer into the fabric layer for scarf joint with the fibers of the fabric layer. The storage of the yoga mates in the aforesaid prior art is only limited to the roll-up manner, by which the user-contact surface, i.e. the top side of the yoga mat, keeps close contact with the bottom side of the same, such that the user-contact surface may be stained by the bottom side if it is dirty.

### SUMMARY OF THE INVENTION

The primary objective of the present invention is to provide an anti-skid exercise mat, which provides the user with the feeling of softness and comfortableness and with preferable absorption of perspiration and anti-skid function during the whole course of exercise.

The secondary objective of the present invention is to provide an anti-skid exercise mat, which has a clean storage manner.

The foregoing objectives of the present invention are attained by the anti-skid exercise mat composed of a foam member having a predetermined thickness, a fabric layer located on at least one side of the foam member, and at least one soft plastic material disposed on a predetermined area of a surface of the fabric layer and at least penetrating into the fabric layer for a predetermined depth for scarf joint and adhesive connection with the fibers of the fabric layer.

### BRIEF DESCRIPTION OF THE DRAWINGS

FIG. 1 is a perspective view of a conventional exercise mat having a foam member only.

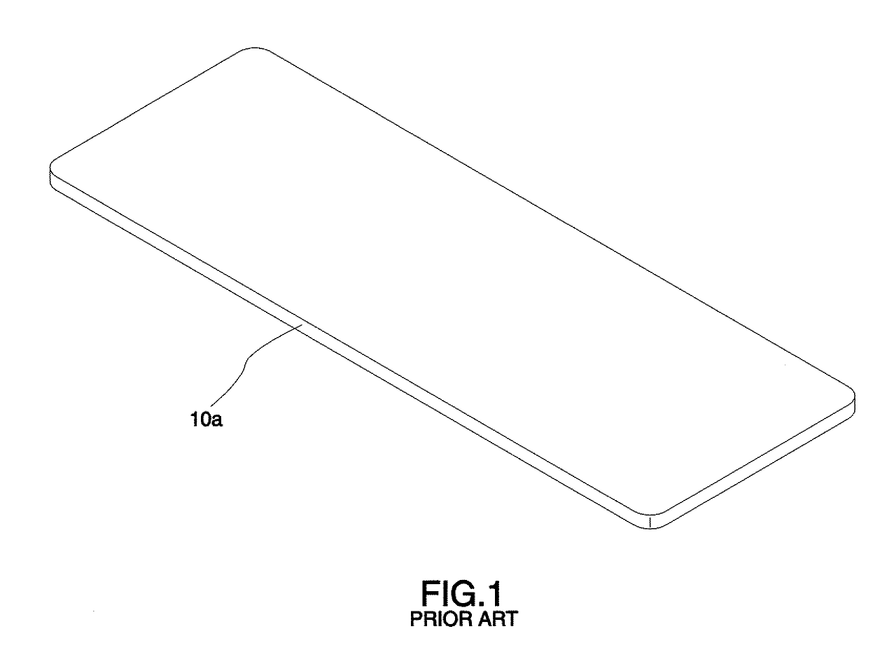

FIG. 2 is a perspective view of the conventional exercise mat having a foam member and a plastic or rubber leather layer located on a surface of the foam member.

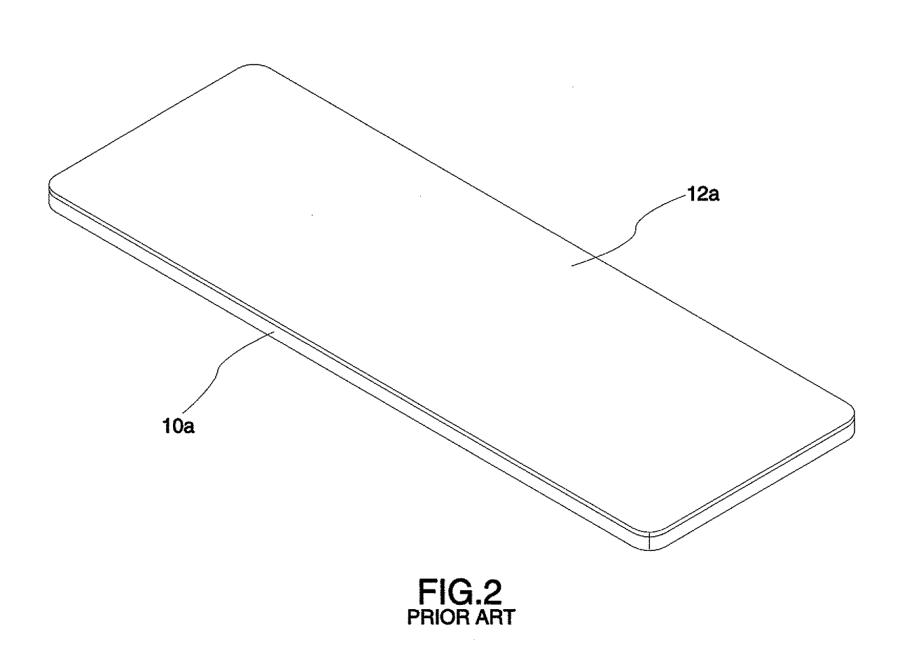

FIG. 3 is a perspective view of another conventional exercise mat having a foam member and a fabric layer located on the foam member.

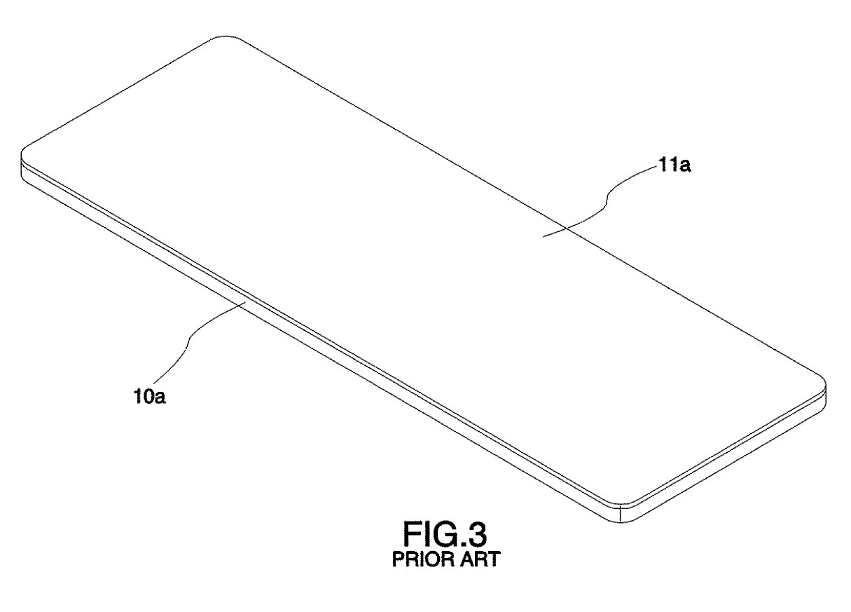

FIG. 4 is a perspective view of a first preferred embodiment of the present invention.

FIG. 5 is a perspective view of a part of the first preferred embodiment of the present invention.

FIG. 6 is a schematic view of the first preferred embodiment of the present invention, illustrating that the fabric layer is combined with the soft plastic material.

FIG. 7 is a perspective view of a split part of a second preferred embodiment of the present invention.

FIG. 8 is a perspective view of a third embodiment of the present invention.

FIG. 9 is a side view of third embodiment of the present invention at work.

FIG. 10 is a schematic view of the first preferred embodiment of the present invention.

FIG. 11 shows an alternative formation of the soft plastic material.

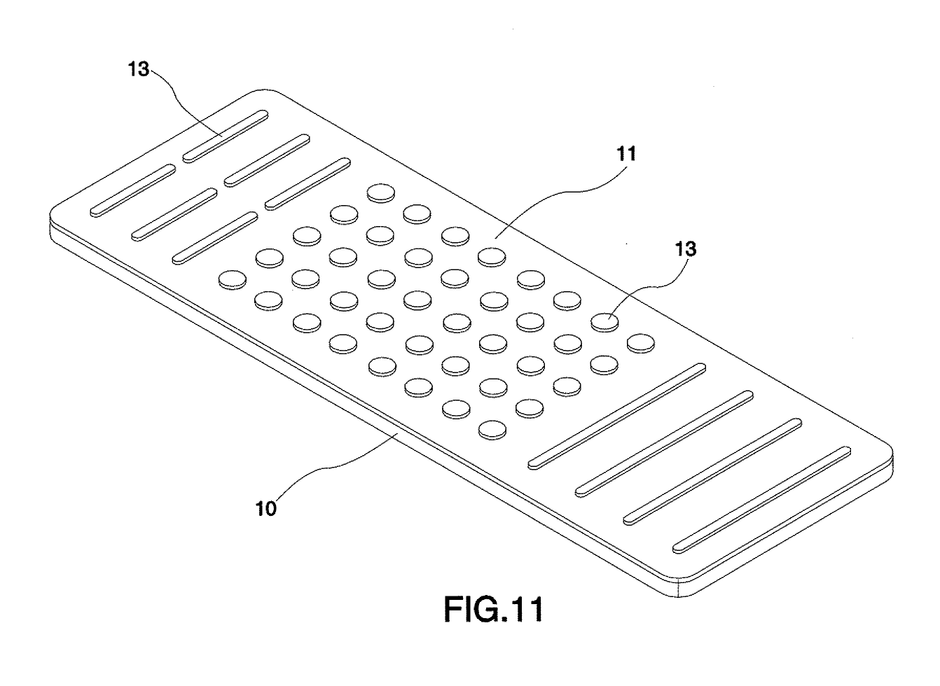

FIG. 12 shows an arrangement of the soft plastic material.

FIG. 13 shows an alternative arrangement of the soft plastic material.

FIG. 14 shows an alternative structure of the fabric layer.

### DETAILED DESCRIPTION OF PREFERRED EMBODIMENTS

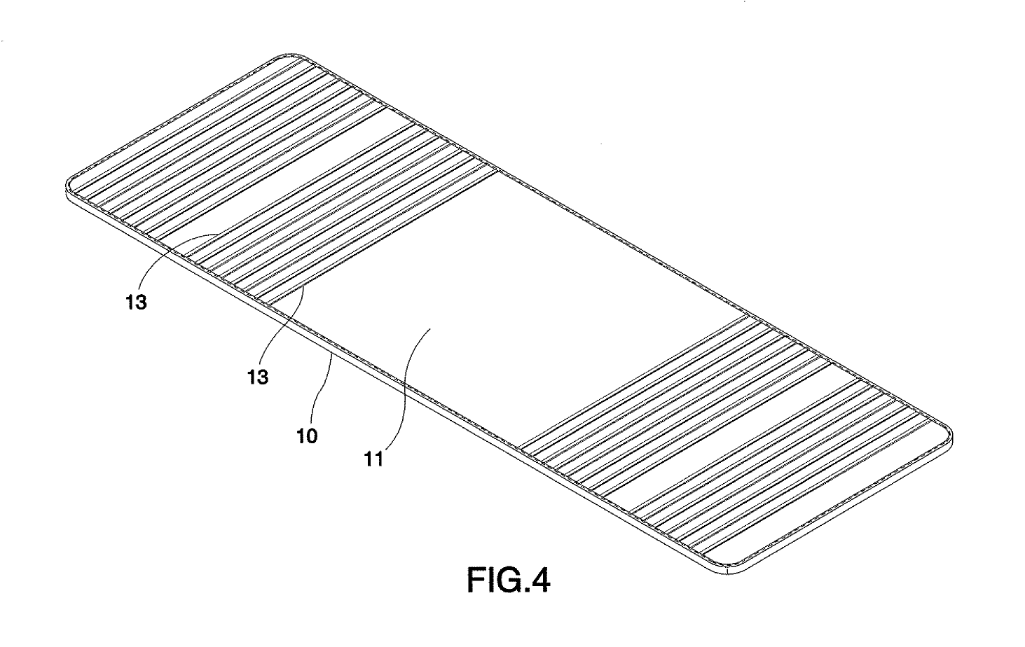

Referring to FIGS. 4-6, an anti-skid exercise mat constructed according to a first preferred embodiment of the present invention is composed of a foam member 10, a fabric layer 11, and a plurality of soft plastic materials 13.

The foam member 10 has a predetermined thickness.

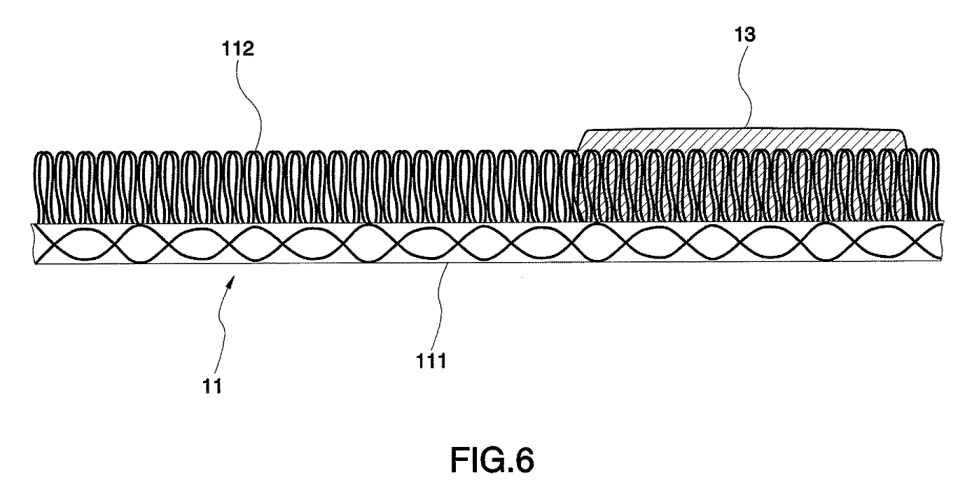

The fabric layer 11 is attached to at least one side of the foam member 10. The fabric layer 11 includes a bottom sub-layer 111 and a ciliary sub-layer 112 formed on a surface of the bottom sub-layer 111 and having a plurality of cilia, as shown in FIG. 6.

The soft plastic materials 13 can be plastics or rubber and disposed onto a predetermined area of a surface of the fabric layer 11. The soft plastic material 13s penetrate into the fabric layer 11 for a predetermined depth. In this embodiment, the soft plastic materials 13 penetrate into the ciliary sub-layer 112 to be disposed among and to cling to the cilia, as shown in FIG. 6, for scarf joint and adhesive connection with the fibers of the fabric layer 11. Each of the soft plastic materials 13 is rectangular in shape and disposed on the fabric layer 11 to extend from one of two sides of the foam member 10 to the other side. The soft plastic materials 13 are parallel to one another, spaced for a predetermined interval therebetween, and arranged regularly.

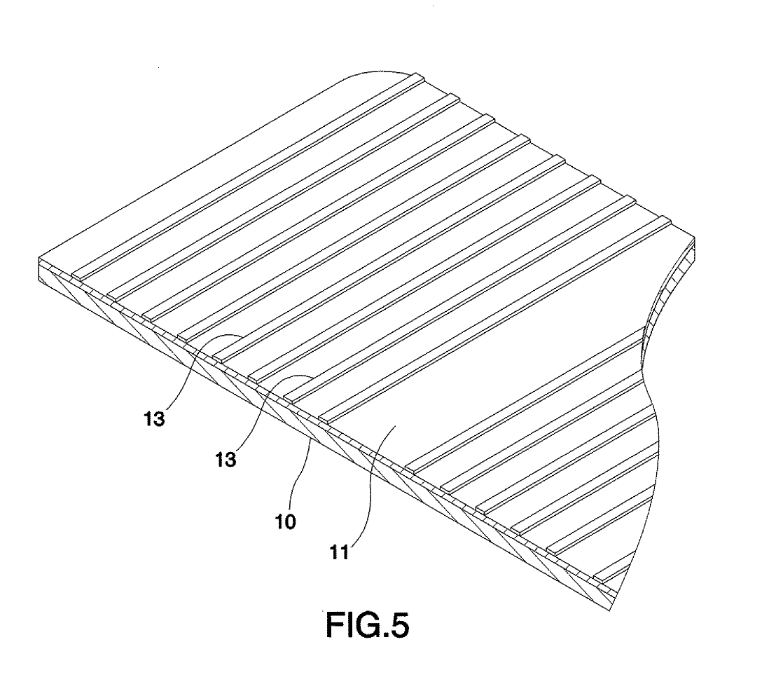

In addition, the fabric layer 11 is adhesively fixed to the surface of the foam member 10. The soft plastic materials 13 each have a predetermined thickness of 0.01-0.7 cm, being strip-shaped and bossed. FIG. 5 shows a sectional view of the fabric layer 11 adhesively fixed to the foam member 10.

In light of the above, the present invention includes the fabric layer 11 and the soft plastic materials 13 disposed on the surface thereof. When the user exercises on the exercise mat of the present invention, the exercise mat can absorb perspiration and stop slipperiness by the fabric layer 11, while the user's hands sweat, and stop slipperiness by the soft plastic materials 13, while the user's hands do not sweat, thus being anti-skid during the whole course of exercising. Besides, the soft plastic materials 13 are embedded into the ciliary sub-layer 112 to cling to the cilia to have preferable adhesivity. Under the normal condition, the soft plastic materials 1 dos not disengage from the baric layer 11.

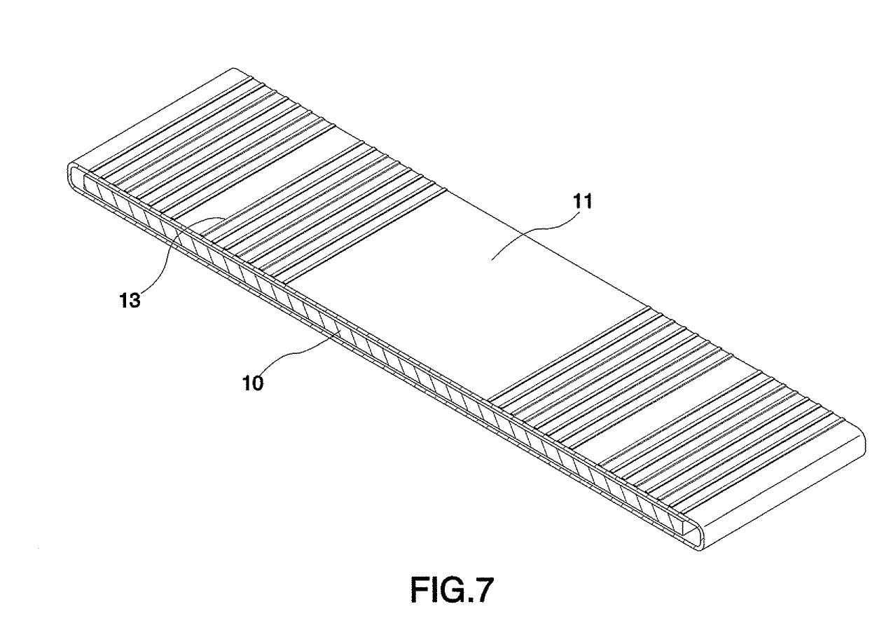

Referring to FIG. 7, an anti-skid exercise mat constructed according to a second preferred embodiment of the present invention is similar to that of the first embodiment and different form each other in that the fabric layer 11 encases the foam member 10.

The other structures and functions of the second embodiment are identical to those of the first embodiment, such that no more recitation in this regard is necessary.

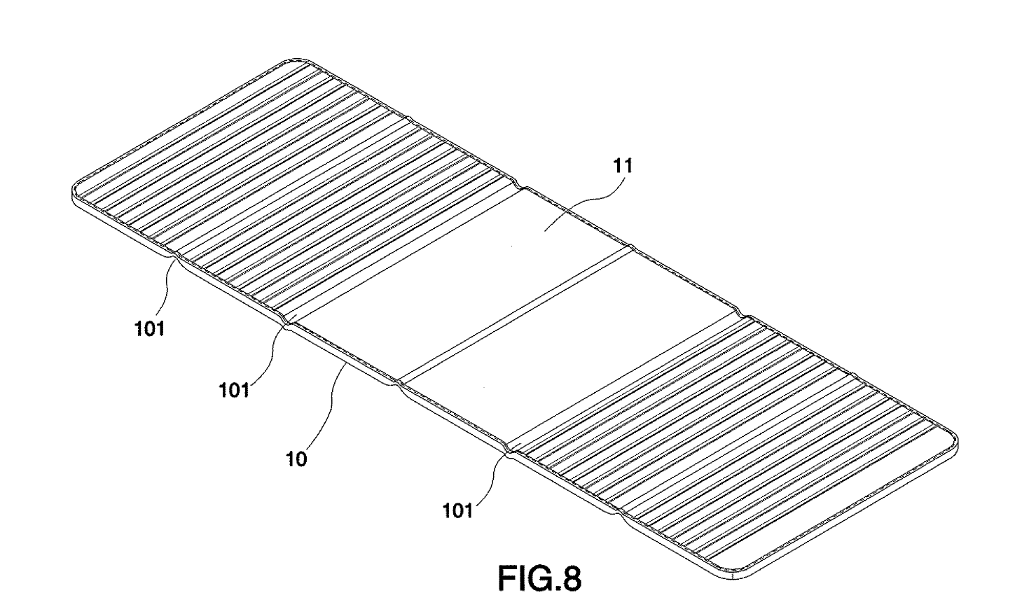

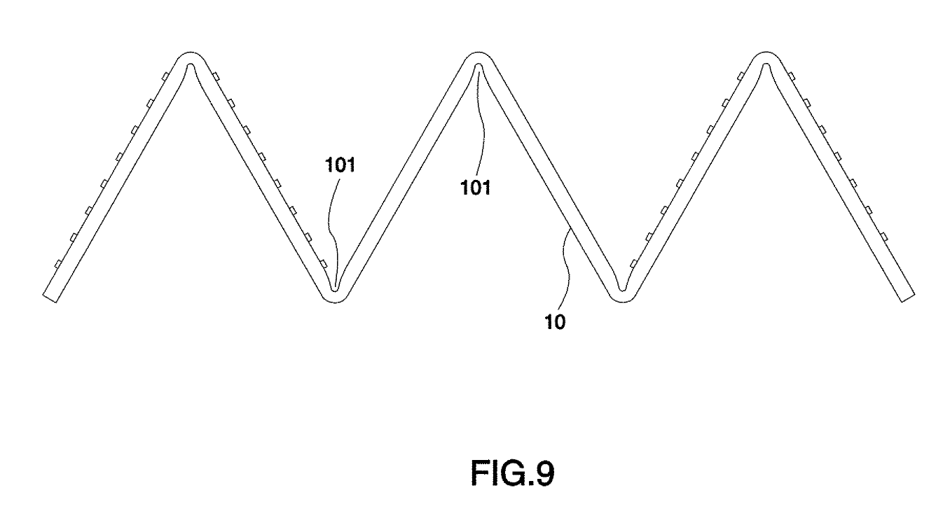

Referring to FIGS. 8-9, an anti-skid exercise mat constructed according to a second preferred embodiment of the present invention is similar to that of the first embodiment, having the following differences. The foam member 10 includes a plurality of creases 101 for facilitating bending thereof. As the foam member 10 is bent, the fabric layer 11 is also bent. Because the fabric layer 11 is mounted on the surface of the foam member 10 and bent as the foam member 10 is bent, some of the creases 101 as indicated in FIGS. 8-9 are located on the fabric layer 11.

In addition, the creases 101 are alternately arranged on the top and bottom sides of the fabric layer 11 in such that the anti-skid exercise mat is W-shaped while it is multi-bent.

In this way, sections are formed between the creases 101 on a user-contact surface, i.e. the top side of the fabric layer 11, and the adjacent sections keep contact with each other without contacting the bottom side of the anti-skid exercise mat while the anti-skid exercise mat is multi-bent. Generally speaking, the bottom side of the anti-skid exercise mat is put on the ground and thus may be dirty, such that the user-contact surface may contact the bottom side of the anti-skid exercise mat to be stained if the anti-skid exercise mat is stored by the conventional manner, e.g. roll-up. Therefore, the bending-type storage is cleaner and more hygienic than the conventional roll-up one to be more acceptable for the user.

The other structures and functions of the third embodiment are identical to those of the first embodiment, such that no more recitation in this regard is necessary.

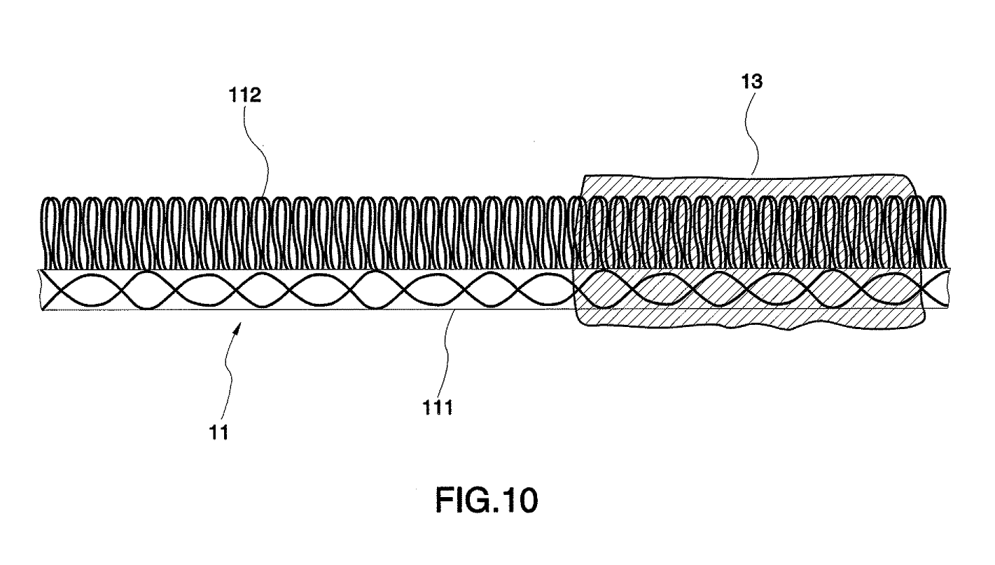

Referring to FIG. 10, an anti-skid exercise mat constructed according to a fourth preferred embodiment of the present invention is similar to that of the first embodiment, having the following differences. The soft plastic materials 13 penetrate into the midst of the cilia of the ciliary sub-layer 112 to cling to the cilia. The soft plastic materials 13 can further penetrate into the bottom sub-layer 111 and through the bottom side of the fabric layer 11. The soft plastic materials 13 can be very tightly combined with the fabric layer 11. The other structures and functions of the fourth embodiment are identical to those of the first embodiment, such that no more recitation in this regard is necessary.

The aforesaid four embodiments though specify the primary technical features of the present invention, but under the spirit of the present invention, the shape of and how to mount the soft plastic materials 13 are interchangeable to fall within the scope of the claim of the present invention.

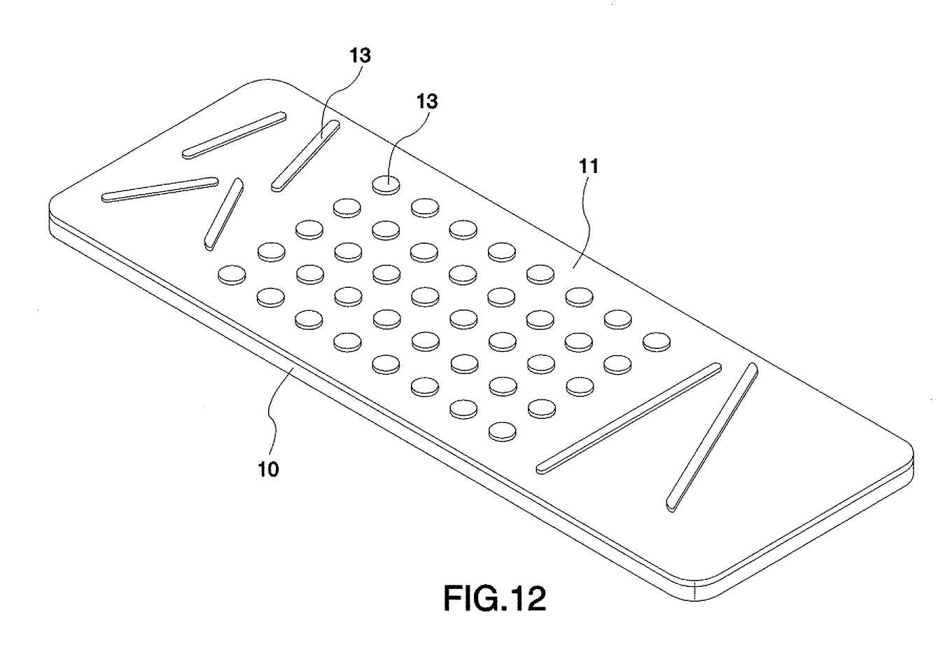

Referring to FIG. 12, the arrangement of the soft plastic materials 13 fixed to the fabric layer 11 can alternatively be partially regular and partially irregular.

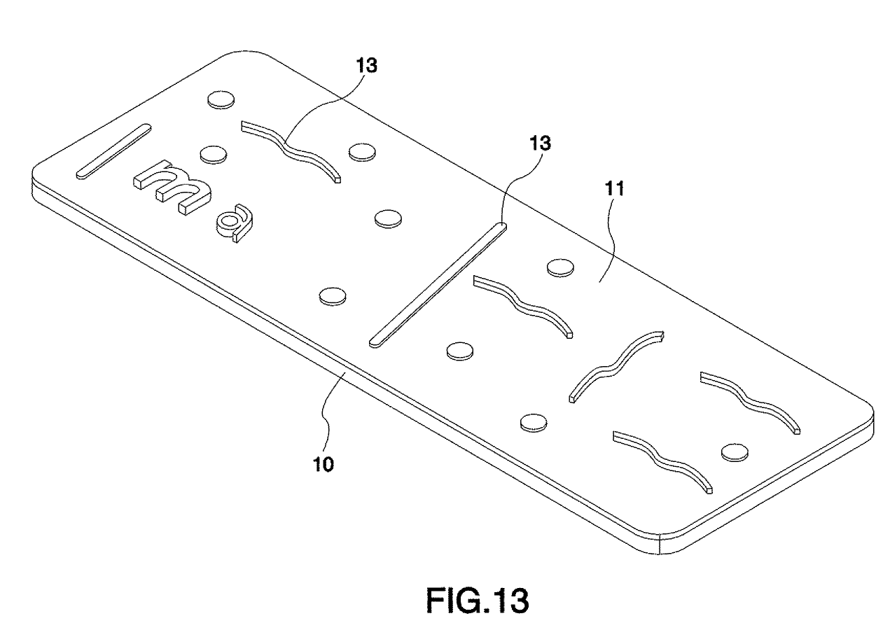

Referring to FIG. 13, the arrangement of the soft plastic materials 13 fixed to the fabric layer 11 can be alternatively irregular.

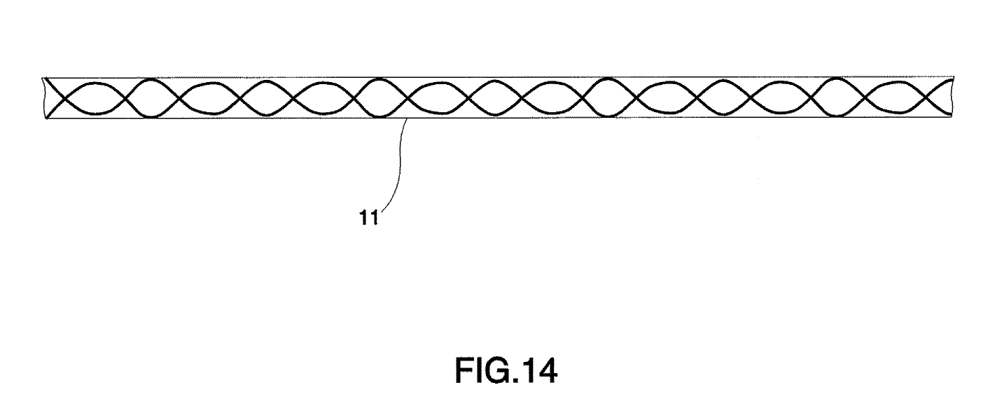

In addition, the fabric layer 11 can alternatively be made by plain weave, as shown in FIG. 14.

In conclusion, the present invention includes the following advantages.

1. The soft plastic materials penetrate into the fabric layer to be much more tightly combined with the fabric layer than the prior art.

2. The creases can prevent the user-contact surface from contact with the bottom side of the fabric layer and thus from dirtiness in such a way that the present invention can be stored in the cleaner way than the prior art.

Although the present invention has been described with respect to specific preferred embodiments thereof, it is no way limited to the details of the illustrated structures but changes and modifications may be made within the scope of the appended claims.

What is claimed is:

1. An anti-skid exercise mat comprising:
a foam member having a predetermined thickness;
a fabric layer mounted to at least one side of said foam member; and
at least one soft plastic material disposed on a predetermined area of a surface of said fabric layer and at least penetrating into the fabric layer for a predetermined depth for scarf joint and adhesive connection with fibers of the fabric layer.

2. The anti-skid exercise mat as defined in claim 1, wherein said fabric layer is fixed to said foam member.

3. The anti-skid exercise mat as defined in claim 2, wherein said fabric layer is attached to said foam member.

4. The anti-skid exercise mat as defined in claim 1, wherein said fabric layer packages said foam member.

5. The anti-skid exercise mat as defined in claim 1, wherein said at least one soft plastic material is plural in number.

6. The anti-skid exercise mat as defined in claim 5, wherein said soft plastic material is provided with a predetermined thickness.

7. The anti-skid exercise mat as defined in claim 6, wherein the thickness of said soft plastic material is 0.01-0.7 cm.

8. The anti-skid exercise mat as defined in claim 5, wherein said soft plastic materials are elongated and regularly arranged on said fabric layer.

9. The anti-skid exercise mat as defined in claim 8, wherein the soft plastic materials extend from one of two sides of the foam member to the other side and are parallel to each other and spaced for a predetermined interval therebetween.

10. The anti-skid exercise mat as defined in claim 5, wherein said soft plastic materials are strip-shaped and irregularly arranged on said fabric layer.

11. The anti-skid exercise mat as defined in claim 5, wherein said soft plastic materials are bossed.

12. The anti-skid exercise mat as defined in claim 1, wherein the fabric layer comprises a bottom sub-layer and a ciliary sub-layer located on a surface of the bottom sub-layer, the ciliary sub-layer having a plurality of cilia.

13. The anti-skid exercise mat as defined in claim 12, wherein the soft plastic materials penetrate into the midst of the cilia of the ciliary sub-layer to cling to the cilia.

14. The anti-skid exercise mat as defined in claim 13, wherein the soft plastic materials further penetrate into the bottom sub-layer and through the bottom side of the fabric layer.

15. The anti-skid exercise mat as defined in claim 1, wherein the foam member comprises a plurality of creases for facilitating bending thereof; as the foam member is bent, the fabric layer is also bent.

16. The anti-skid exercise mat as defined in claim 15, wherein the creases are alternately arranged on the top and bottom sides thereof, whereby the foam member is W-shaped as it is bent.
